(19) United States
(12) Patent Application Publication
(10) Pub. No.: US 2026/0280790 A1
(43) Pub. Date: Sep. 17, 2026

(54) UPLINK TIME DOMAIN RESOURCE ASSIGNMENT ACROSS SLOTS ENHANCEMENT

(71) Applicant: Nokia Technologies Oy, Espoo (FI)

(72) Inventors: Jie GAO, Zhejiang (CN); Jingyuan SUN, Beijing (CN); Nhat-Quang NHAN, Reims (FR); Youngsoo YUK, Seoul (KR); Erika PORTELA LOPES DE ALMEIDA, Aalborg (DK)

(21) Appl. No.: 19/479,988

(22) PCT Filed: May 5, 2023
(86) PCT No.: PCT/CN2023/092383

§ 371 Date: Oct. 29, 2025

(51) Int. Cl. H04L 5/00; H04L 5/14

(52) U.S. Cl. CPC H04L 5/0044; H04L 5/1469

(57) ABSTRACT

Embodiments of the present disclosure relate to devices, methods, apparatuses and computer readable storage media of uplink Time Domain Resource Assignment (TDRA) resource assignment across slots enhancement. The method comprises receiving, at a first apparatus and from a second apparatus, a message indicating time domain resource allocation for an uplink transmission that spans across at least two consecutive slots and that comprises a set of subband full duplex (SBFD) symbols; determining a start location of the set of SBFD symbols in a time domain at least based on the message; and performing the uplink transmission to the second apparatus at least based on the start location of the set of SBFD symbols.

### FIELD

Embodiments of the present disclosure generally relate to the field of telecommunication and in particular to devices, methods, apparatuses and computer readable storage media of uplink Time Domain Resource Assignment (TDRA) resource assignment across slots enhancement.

### BACKGROUND

3rd Generation Partnership Project (3GPP) 5th Generation Mobile Communication Technology (5G) New Radio (NR) currently supports two duplexing modes, namely Frequency Division Duplexing (FDD) for paired bands and TDD for unpaired bands. In TDD, the time domain resource may be split between downlink and uplink. Allocation of a limited time duration for the uplink in TDD may result in reduced coverage, increased latency, and reduced capacity. Therefore, a study of subband non-overlapping full duplex (SBFD) is initiated in the release 18.

### SUMMARY

In a first aspect, there is provided a first apparatus. The first apparatus comprises at least one processor; and at least one memory storing instructions that, when executed by the at least one processor, cause the first apparatus at least to: receive, from a second apparatus, a message indicating time domain resource allocation for an uplink transmission that spans across at least two consecutive slots and that comprises a set of subband full duplex (SBFD) symbols; determine a start location of the set of SBFD symbols in a time domain at least based on the message; and perform the uplink transmission to the second apparatus at least based on the start location of the set of SBFD symbols.

In a second aspect, there is provided a second apparatus. The second apparatus comprises at least one processor; and at least one memory storing instructions that, when executed by the at least one processor, cause the second apparatus at least to: determine a message indicating time domain resource allocation for an uplink transmission that spans across at least two consecutive slots and that comprises a set of SBFD symbols; and transmit the message to a first apparatus.

In a third aspect, there is provided a method. The method comprises receiving, at a first apparatus and from a second apparatus, a message indicating time domain resource allocation for an uplink transmission that spans across at least two consecutive slots and that comprises a set of SBFD symbols; determining a start location of the set of SBFD symbols in a time domain at least based on the message; and performing the uplink transmission to the second apparatus at least based on the start location of the set of SBFD symbols.

In a fourth aspect, there is provided a method. The method comprises determining, at a second apparatus, a message indicating time domain resource allocation for an uplink transmission that spans across at least two consecutive slots and that comprises a set of SBFD symbols; and transmitting the message to a first apparatus.

In a fifth aspect, there is provided a first apparatus comprising means for receiving, from a second apparatus, a message indicating time domain resource allocation for an uplink transmission that spans across at least two consecutive slots and that comprises a set of SBFD symbols; means for determining a start location of the set of SBFD symbols in a time domain at least based on the message; and means for performing the uplink transmission to the second apparatus at least based on the start location of the set of SBFD symbols.

In a sixth aspect, there is provided a second apparatus comprising means for determining, at a second apparatus, a message indicating time domain resource allocation for an uplink transmission that spans across at least two consecutive slots and that comprises a set of SBFD symbols; and means for transmitting the message to a first apparatus.

In a seventh aspect, there is provided a computer readable medium having a computer program stored thereon which, when executed by at least one processor of an apparatus, causes the apparatus to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating an example of process according to some example embodiments of the present disclosure;

FIG. 3 shows an example of determining a start location of time domain resource allocation for an uplink transmission comprising a set SBFD symbols according to some example embodiments of the present disclosure;

FIG. 4 shows an example of determining a start location of time domain resource allocation for an uplink transmission comprising a set SBFD symbols according to some example embodiments of the present disclosure;

FIG. 5 shows an example of determining a start location of time domain resource allocation for an uplink transmission comprising a set SBFD symbols according to some example embodiments of the present disclosure;

FIG. 6 shows a flowchart of an example method of uplink TDRA resource assignment across slots enhancement according to some example embodiments of the present disclosure;

FIG. 7 shows a flowchart of an example method of uplink TDRA resource assignment across slots enhancement according to some example embodiments of the present disclosure;

FIG. 8 shows a simplified block diagram of a device that is suitable for implementing example embodiments of the present disclosure; and

FIG. 9 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, low earth orbit (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

FIG. 1 shows an example communication network 100 in which embodiments of the present disclosure may be implemented. As shown in FIG. 1, the communication network 100 may include a first apparatus 110. Hereinafter the first apparatus 110 may also be referred to as a UE or a terminal device.

The communication network 100 may further include a second apparatus 120. Hereinafter the second apparatus 120 may also be referred to as a gNB or a network device. The first apparatus 110 may communicate with the second apparatus 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the second apparatus 120 to the first apparatus 110 may be referred to as a downlink (DL), while links from the first apparatus 110 to the second apparatus 120 may be referred to as an uplink (UL). In DL, the second apparatus 120 is a transmitting (TX) device (or a transmitter) and the first apparatus 110 is a receiving (RX) device (or receiver). In UL, the first apparatus 110 is a TX device (or transmitter) and the second apparatus 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), 5G, the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), FDD, TDD, Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The current two duplexing modes in 3GPP 5G NR are facing challenges that allocating the limited time duration in the duplexing modes can result in reduced capabilities. To address this challenge, 3GPP has agreed to initiate a release 18 study item on the evolution of duplexing operations in NR. One of the objectives of the study item is to allow simultaneous DL and UL transmission on different physical resource blocks (PRBs)/subbands within an unpaired wideband NR cell. In the present disclosure, this duplexing scheme is referred to as SBFD. In other sources, this duplexing scheme is also referred to as cross-division duplexing (xDD) scheme or Flexible Duplexing (FDU).

The discussion on subband non-overlapping full duplex may mainly focus on the following aspects. First, the discussion may study whether or not a slot can consist of both SBFD and non-SBFD symbols, which refers to benefits, uses cases, scheduling flexibility, Implementation complexity, and compatibility with conventional TDD DL/UL configuration.

Second, for UL transmissions and DL receptions across SBFD symbols and non-SBFD symbols in different slots (each transmission/reception within a slot has either all SBFD or all non-SBFD symbols), the following options for SBFD-aware UEs are to be studied:
Option 1: The transmissions/receptions are restricted to SBFD symbols only or non-SBFD symbols only;
Option 2: The transmissions/receptions can be in SBFD symbols and non-SBFD symbols.

Furthermore, UL transmissions and DL receptions across SBFD symbols and non-SBFD symbols include the following:
physical downlink shared channel (PDSCH)/physical uplink shared channel (PUSCH)/physical uplink control channel (PUCCH) repetitions;
Semi-persistent Scheduling (SPS) PDSCH/Configured Grant (CG) PUSCH;
transport block processing over multiple slots PUSCH (TBoMS);
Multi-PUSCH/PDSCH scheduled by a single downlink control information (DCI)
Periodic/semi-persistent sounding reference signal (SRS)/channel state information reference signal (CSI-RS)/PUCCH
physical downlink control channel (PDCCH)

Moreover, at least the followings for SRS, PUCCH and PUSCH on SBFD symbols and non-SBFD symbols in different slots may also be studied in the discussion:
Whether/how to have separate resources;
Whether/how to have separate FH parameters;
Whether/how to have separate UL power control parameters;
Whether/how to have separate beam/spatial relation.

On the other hand, several techniques that allow scheduling multiple UL or DL transmissions in multiple slots with a single scheduling DCI have been specified and improved in the previous releases of 3GPP specifications.

For uplink transmissions, there exist two techniques that allow scheduling multiple UL transmissions in multiple slots using a single DCI, which are referred to as PUSCH repetitions and multi-PUSCH scheduling. These techniques have the following common design aspects:

The single DCI schedules multiple PUSCHs, each PUSCH is within a slot.

The scheduled PUSCHs have the same frequency domain resource allocation (i.e., the same number of physical resource blocks (PRBs) and the same location of these PRBs in frequency domain), which is indicated by the single DCI.

However, these techniques have the following different design aspects. For the PUSCH repetition, only a single starting and length of a PUSCH within a slot is indicated by the scheduling DCI, i.e., a single start and length indicator value (SLIV). This single SLIV is used by the UE for determining the time domain resource for the scheduled PUSCH in each slot, depending on the PUSCH repetition type.

As an option, for PUSCH repetition type A: The same start and length indicated by the single SLIV is applied across all scheduled PUSCHs.

As another option, for PUSCH repetition type B: The single SLIV is used for determining multiple back-to-back nominal repetitions with the same length and each nominal repetition can span across the slot boundary. Then, each nominal repetition is split into multiple actual repetitions if it crosses the slots boundary or invalid symbols.

Furthermore, all the PUSCH repetitions are used for transmitting a single transport block using different redundancy versions and the same Hybrid Automatic Repeat reQuest (HARQ) process number.

For multi-PUSCH scheduling, multiple SLIVs can be indicated by the scheduling DCI, each valid SLIV corresponds to one PUSCH from the multiple scheduled PUSCHs. The scheduled PUSCHs are used for transmitting different transport blocks with different HARQ process numbers. In the following description, term PUSCH mapping is used to encompass all these PUSCH transmission/reception types from the perspective of time-domain resource allocation. The term ‘PUSCH mapping’ follows the meaning of the same term in the literature, e.g., the 3GPP standard specifications.

In a case where a slot comprises both SBFD and non-SBFD symbols, different kinds of potential slot types for the slot that consist of both SBFD and non-SBFD symbols. In this situation, SBFD has continuous UL slot/symbols and the number of UL symbols may be different in different slots.

On the one hand, using a scheduling method, i.e., one DCI corresponds to one slot, may greatly increase the number of control channel resources. There is no existing scheduling approach that allows scheduling resource for one transmission across slot boundary (note that PUSCH repetition type B requires splitting into different actual repetitions when a repetition/transmission spans across slot boundary, while PUSCH repetition type A and TB processing over multiple slots (TBoMS) require the starting and length of the allocation per slot should be the same across the allocated slots).

In the solution of the present disclosure, there is proposed a scheduling method that allows transmissions across slots while not increasing the required number of resources used for the control channel. In this solution, the second apparatus 120 may transmit a message indicating time domain resource allocation for an uplink transmission that spans across at least two consecutive slots and that comprises a set of SBFD symbols to the first apparatus 110. The first apparatus determines a start location of the set of SBFD in a time domain at least based on the message and performs the uplink transmission to the second apparatus at least based on the start location of the set of SBFD symbols.

In this way, resource utilization for a single scheduling can be improved and different TDRAs across slots can be supported.

Example embodiments of the present disclosure will be described in detail below with reference to the accompanying drawings.

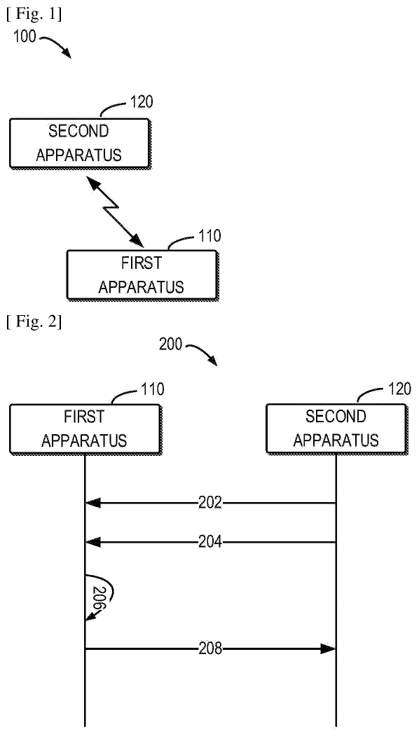

Reference is now made to FIG. 2, which shows a signaling chart 200 for communication according to some example embodiments of the present disclosure. As shown in FIG. 2, the signaling chart 200 involves the first apparatus 110 and the second apparatus 120. For the purpose of discussion, reference is made to FIG. 1 to describe the signaling chart 200. It is to be understood that the process shown in FIG. 2 may also be adopted by other apparatus.

As shown in FIG. 2, the second apparatus 120 may indicate (202), to the first apparatus 110, configuration of resources in a frequency domain and/or in a time domain associated with the first apparatus 110.

For example, the second apparatus 120 may indicate a frequency band available for the first apparatus 110.

Furthermore, the second apparatus 120 may indicate a number of SBFD slots/symbols in a case where the frequency band is split into multiple subbands, wherein at least one subband is used for DL transmissions and at least one subband is used for UL transmissions, and locations of the number of SBFD slots/symbols in a radio frame. That is, the second apparatus 120 may indicate a range of resources for a SBFD operation in the time domain, for example, a structure of one or more SBFD slots.

In a case where the SBFD symbols are included in at least two consecutive slots, the second apparatus 120 may indicate in which time slot and on which symbol the first SBFD symbol of a number of SBFD symbols starts. Hereinafter the slot containing the first SBFD symbol may be referred to as the first SBFD slot.

The second apparatus 120 may also indicate a number of non-SBFD slots/symbols in a case where the entire frequency band is used for DL transmissions or UL transmissions or flexible transmission and locations of the number of slots/symbols in a radio frame.

The second apparatus 120 may transmit (204) to the first apparatus 110, a message indicating time domain resource allocation for an uplink transmission of first apparatus 110. The uplink transmission spans across at least two consecutive slots and comprises a set of SBFD symbols. The SBFD symbols may be comprised in all of the at least two consecutive slots or in a subset of the at least two consecutive slots. For example, a first slot may comprise some of the SBFD symbols while a consecutive second slot may comprise the remaining SBFD symbols. Alternatively, the first slot or the second slot may comprise all the SBFD symbols of the two slots. Similar logic may be applied when the number of slots is greater than two.

Then the first apparatus may determine (206) a start location of the set of SBFD symbols in a time domain at least based on the message.

In some embodiments, the first apparatus 110 may obtain SLIV from the message and determine the start location of the set of SBFD symbols based on the SLIV and the range of resources for a SBFD operation in the time domain.

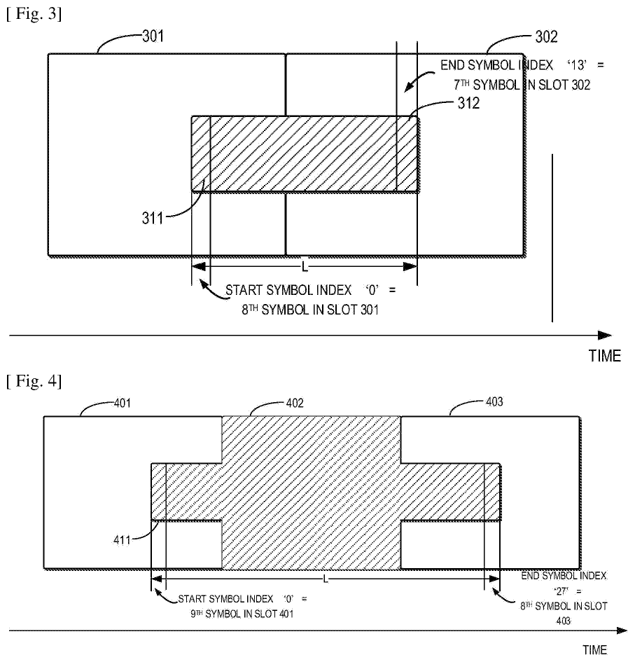

FIGS. 3-5 show examples resource allocation of the set of SBFD symbols according to some example embodiments of the present disclosure. Example embodiments for determining the start location of the set of SBFD symbols may be explained in detail with reference to FIGS. 3-5 as below.

In some embodiments, if the length of the set of SBFD symbols does not exceed a threshold length and in a case of PUSCH mapping Type A or PUSCH mapping Type B, the first apparatus 110 may determine the start location of the set of SBFD symbols in the time domain based on the SLIV and the range in the time domain available for the SBFD operation. The start symbol index indicated by the SLIV may be relative to the start location of the first SBFD symbol in the first SBFD slot.

As shown in FIG. 3, the set of SBFD symbols spans in this embodiment across two consecutive slots 301 and 302 and a length of the set of SBFD symbols does not exceed the threshold which in this embodiment is 14 symbols (e.g., equals to 14 symbols).

The message received by the first apparatus 110 from the second apparatus 120 may be listed as below.

TABLE 1
an example of RRC configuration

```
pusch-ConfigCommon: setup (1)
  setup
    pusch-TimeDomainAllocationList: 4 items
      Item 0
      PUSCH-TimeDomainResourceAllocation
        k2: 2
        mappingType: typeB (1)
        startSymbolAndLength: 27------(s=0, l=14)
        additional symbols:0
```

In this case, the first apparatus 110 may obtain the SLIV (i.e., 27) from the message. Then the first apparatus 110 may determine the start symbol index S based on the following process:

$$if ( L - 1 ) \leq 7 then \\ SLIV = 14 \cdot ( L - 1 ) + S \\ else \qquad ( 1 )$$

$$SLIV = 14 \cdot ( 14 - L + 1 ) + ( 14 - 1 - S ) \qquad ( 2 )$$

Where 0<L≤14-S

Based on the equation (1), with the SLIV=27, the first apparatus 110 may determine that the start symbol index S-0 and the number of consecutive symbols L counting from the symbol S allocated for the PUSCH L=14. As described above, the start symbol index indicated by the SLIV may be relative to the start location of the first SBFD symbol in the first SBFD slot. Based on the range in the time domain available for the SBFD operation, the first apparatus 110 knows that the first SBFD symbol 311 starts from the eighth symbol in the first SBFD slot 301. Thus, the start symbol index S=0 is relative to the eighth symbol in the first SBFD slot, which may be determines as the start location of the set of SBFD symbols.

In Table 1, there is an indication associated with additional symbols. If the indication of additional symbols is indicated with value “0”, no additional symbol is needed to be indicated. If the indication of additional symbols is indicated with a value “n”, then n*14 additional symbols (i.e., symbols more than 14) are added. In this case, since the additional symbols is indicated with value “0” in Table 1, the total number of SBFD is 14. The end SBFD symbol index 13 is the 7th symbol in the slot 302.

In some embodiments, in a case where the length of the set of SBFD symbols exceeds the threshold length, the first apparatus 110 may obtain additional information indicating a number of additional symbols of the uplink transmission exceeding the threshold length and determine the start location of the set of SBFD symbols based on the SLIV, the additional information and the range in the time domain available for the SBFD operation. The start symbol index indicated by the SLIV may be relative to the start location of the first SBFD symbol in the first SBFD slot.

As shown in FIG. 4, the set of SBFD symbols spans across 3 consecutive slots 401, 402 and 403 and a length of the set of SBFD symbols exceeds 14 symbols.

The message received by the first apparatus 110 from the second apparatus 120 may be listed as below.

TABLE 2
an example of RRC configuration

```
pusch-ConfigCommon: setup (1)
  setup
    pusch-TimeDomainAllocationList: 4 items
      Item 0
      PUSCH-TimeDomainResourceAllocation
          k2: 2
          mappingType: typeB (1)
          startSymbolAndLength: 27------(s=0, l=14)
          additional symbols:1----------(new, add 14
        symbols)
```

Similarly, based on the equation (1), with the SLIV=27, the first apparatus 110 may determine that the start symbol index S=0 and the number of consecutive symbols L counting from the symbol S allocated for the PUSCH L=14. As described above, the start symbol index indicated by the SLIV may be relative to the start location of the first SBFD symbol in the first SBFD slot. Based on the range in the time domain available for the SBFD operation, the first apparatus 110 knows that the first SBFD symbol 411 starts from the eighth symbol in the first SBFD slot 401. Thus, the start symbol index S=0 is relative to the eighth symbol in the first SBFD slot, which may be determines as the start location of the set of SBFD symbols. With the additional symbols value “1”, the length of symbols allocated for the PUSCH is extended by 1*14 symbols. In this case, since the additional symbols is indicated with value “1”, the total number of SBFD is 28. The end SBFD symbol index 27 is the 8th symbol in the slot 403.

In some embodiments, the start location of the set of SBFD symbols determined based on the SLIV by the first apparatus 110 may be out of the boundary of the first SBFD slot. In this case, the first apparatus 110 may a new start symbol index based on the start symbol index indicated by the SLIV, the total number of SBFD symbols in the first SBFD slot and a location of the first SBFD symbol in the first SBFD slot.

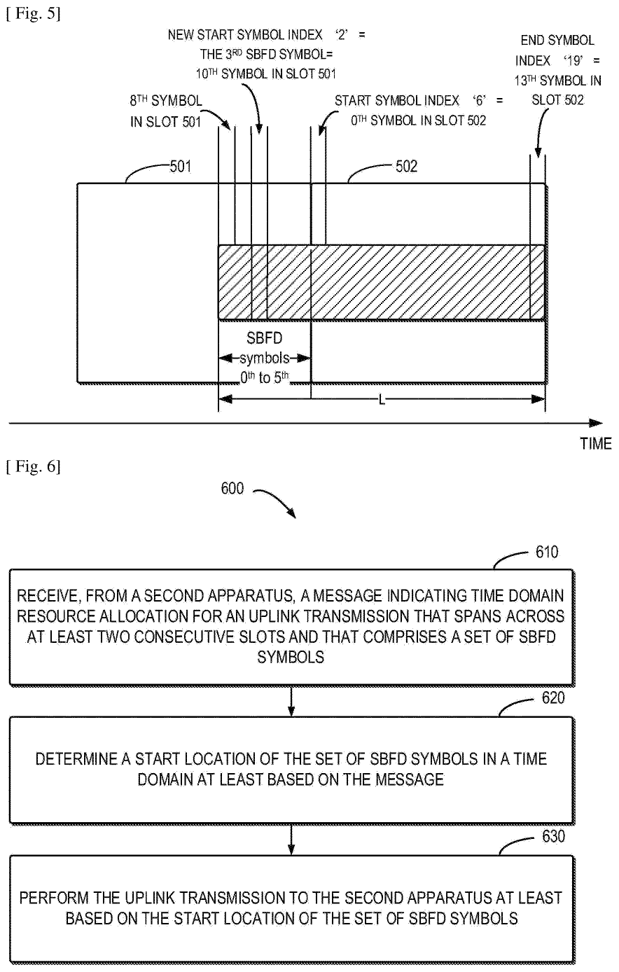

As shown in FIG. 5, the set of SBFD symbols spans across two consecutive slots 501 and 502. The first SBFD slot 501 comprises 6 SBFD symbols (i.e., the 0^{th} symbol to the 5th symbol).

The message received by the first apparatus 110 from the second apparatus 120 may be listed as below.

TABLE 3
an example of RRC configuration

```
pusch-ConfigCommon: setup (1)
  setup
    pusch-TimeDomainAllocationList: 4 items
      Item 0
      PUSCH-TimeDomainResourceAllocation
          k2: 2
          mappingType: typeB (1)
          startSymbolAndLength: 6------(s=6, l=1)
          additional slot:0------(0 means that the
        allocation spans at most 2 slots)
```

With the SLIV=6, the first apparatus 110 may determine that the start symbol index S=6 and the number of consecutive symbols L counting from the symbol S allocated for the PUSCH L=1. As described above, the start symbol index indicated by the SLIV may be relative to the start location of the first SBFD symbol in the first SBFD slot. Based on the range in the time domain available for the SBFD operation, if the start symbol index indication by the SLIV is 6, the first apparatus 110 determines that the start location of the set of SBFD symbols should start from the next SBFD slot, i.e., the slot 502 (as shown in FIG. 5). This is not ideal.

In this case, the first apparatus 110 may calculates a new value s′ of start symbol index based on the following:

$${s}^{′} = mod ( s + {SBFD}_{{symbol}_{1}} , \# {SBFD}_{symbols} ) \qquad ( 3 )$$

whereSBFD_{symbol}_{₁}, stands for an index of slot symbol that corresponds to the first SBFD symbol in this slot (SBFD_{symbol}_{₁}=8 in the FIG. 5) and #SBFD symbols stands for the total number of SBFD symbols in this slot (#SBFD_{symbols}=6 in the FIG. 5).

Then the number of consecutive symbols L counting from the symbol S may be calculated based on:

$$L = 14 + ( \# {SBFD}_{symbols} - {s}^{′} ) \qquad ( 4 )$$

Then the first apparatus 110 may determine the start location of the set of SBFD symbols based on the calculated new start symbol index s′, i.e., 14mod6=2. L may be derived by the first apparatus 110's knowledge about the frame structure. L is given by 18.

Additionally or optionally, an indication of addition slot may also be included to the Table 3, where addition slot value “0” means the allocation spans at most 2 slots and addition slot value “1” means the allocation spans more than 2 slots. In this case, the total number of SBFD is 18. The end SBFD symbol index 19 is the 13th symbol in the slot 502.

After determining the resource allocation of the uplink transmission comprising a set of SBFD symbols that spans across at least two consecutive slots, the first apparatus 110 may perform (208) the uplink transmission to the second apparatus 120.

As described above, the present disclosure proposed an approach for signaling the UL resource allocation in time domain. The concept of relative symbols may be introduced. The specification-based or network-based configuration may be provided to the UE for indicating how to use the uplink of relative location. Start symbol index S indicated by the SLIV for PUSCH transmission may be relative to the first SBFD symbol (instead of the first symbol) in a slot. At the same time, it can be extended to other UL signals and channels, such as PUCCH, PRACH and SRS.

It is to be understood that the legacy UE may still use the SLIV to determine the start location of allocated resources in the time domain if there is no SBFO symbol.

Based on the solution of the present disclosure, resource utilization for a single scheduling can be improved and different TDRAs across slots can be supported.

Furthermore, the number of detections for the control channel and the load on the control channel can be reduced and meanwhile more flexible scheduling and better UL channel estimation is based on more DMRS may be achieved.

FIG. 6 shows a flowchart of an example method 600 of uplink TDRA resource assignment across slots enhancement according to some example embodiments of the present disclosure. The method 600 may be implemented at the first apparatus 110 as shown in FIG. 1. For the purpose of discussion, the method 600 will be described with reference to FIG. 1.

At 610, the first apparatus 110 receives, from a second apparatus 120, a message indicating time domain resource allocation for an uplink transmission that spans across at least two consecutive slots and that comprises a set of SBFD symbols.

At 620, the first apparatus 110 determines a start location of the set of SBFD symbols in a time domain at least based on the message.

At 630, the first apparatus 110 performs the uplink transmission to the second apparatus at least based on the start location of the set of SBFD symbols.

In some example embodiments, the first apparatus 110 may determine a range in a time domain available for a SBFD operation; obtain a SLIV from the message; and determine the location of the set of SBFD symbols in the time domain at least based on the range and the SLIV.

In some example embodiments, in accordance with a determination that a length of the set of SBFD symbols does not exceed a threshold length and in a case of PUSCH mapping Type A or PUSCH mapping Type B, the first apparatus 110 may determine the start location of the set of SBFD symbols in the time domain based on the SLIV and the range in the time domain available for the SBFD operation.

In some example embodiments, in accordance with a determination that the length of the set of SBFD symbols exceeds the threshold length, the first apparatus 110 may obtain, from the message, additional information indicating a number of additional symbols of the uplink transmission exceeding the threshold length; and determine the start location of the set of SBFD symbols based on the SLIV, the additional information and the range in the time domain available for the SBFD operation.

In some example embodiments, the start location of the set of SBFD symbols in the time domain is determined based on a start symbol index indicated by the SLIV and the range in the time domain available for the SBFD operation.

In some example embodiments, in accordance with a determination that a start location of the set of SBFD symbols corresponding to a start symbol index indicated by the SLIV is out of a boundary of the first SBFD slot in the at least two consecutive slots, the first apparatus 110 may determine a new start symbol index based on the start symbol index indicated by the SLIV, the total number of SBFD symbols in the first SBFD slot and a location of the first SBFD symbol in the first SBFD slot; and determine the start location of the set of SBFD symbols in the time domain based on the new start symbol index and the range in the time domain available for the SBFD operation.

In some example embodiments, the first apparatus 110 may obtain, from the message, additional information indicating whether a length of the set of SBFD symbols spans across more than two consecutive slots.

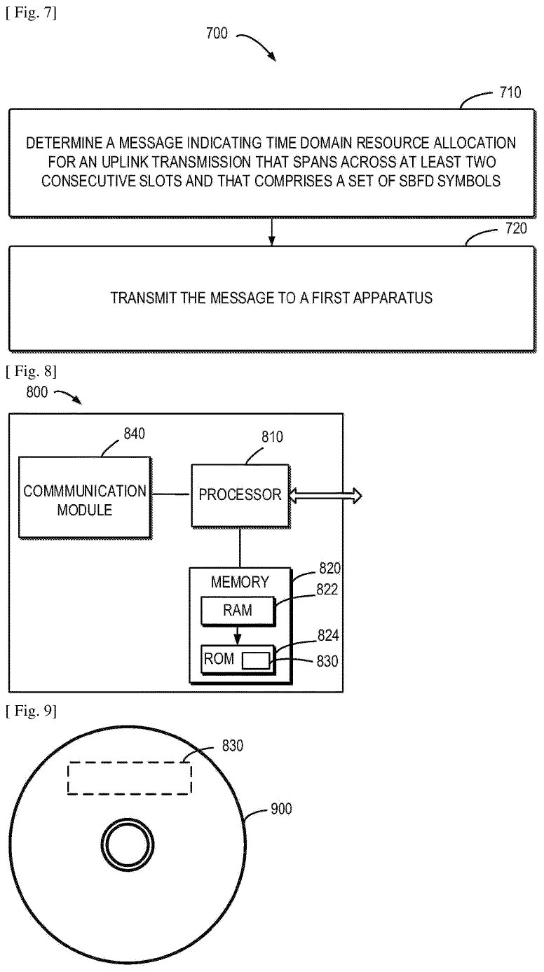

FIG. 7 shows a flowchart of an example method 700 of uplink TDRA resource assignment across slots enhancement according to some example embodiments of the present disclosure. The method 700 may be implemented at the second apparatus 120 as shown in FIG. 1. For the purpose of discussion, the method 700 with be described with reference to FIG. 1.

At 710, the second apparatus 120 determines a message indicating time domain resource allocation for an uplink transmission that spans across at least two consecutive slots and that comprises a set of SBFD symbols.

At 720, the second apparatus 120 transmit the message to a first apparatus 110.

In some example embodiments, the second apparatus 120 may transmit, to the first apparatus, information of a range in a time domain available for a SBFD operation.

In some example embodiments, the second apparatus 120 may transmit, to the first apparatus, a SLIV in the message, wherein a start symbol index indicated by the SLIV is corresponding to a start location of the set of SBFD symbols in the time domain of the range available for the SBFD operation.

In some example embodiments, an apparatus capable of performing the method 600 (for example, implemented at the first apparatus 110) may include means for performing the respective steps of the method 600. The means may be implemented in any suitable form. For example, the means may be implemented in a circuitry or software module.

In some example embodiments, the first apparatus comprises means for receiving, from a second apparatus, a message indicating time domain resource allocation for an uplink transmission that spans across at least two consecutive slots and that comprises a set of SBFD symbols; means for determining a start location of the set of SBFD symbols in a time domain at least based on the message; and means for performing the uplink transmission to the second apparatus at least based on the start location of the set of SBFD symbols.

In some example embodiments, the first apparatus may further comprise means for determining a range in a time domain available for a SBFD operation; means for obtaining a SLIV from the message; and means for determining the location of the set of SBFD symbols in the time domain at least based on the range and the SLIV.

In some example embodiments, the first apparatus may further comprise means for, in accordance with a determination that a length of the set of SBFD symbols does not exceed a threshold length and in a case of PUSCH mapping Type A or PUSCH mapping Type B, determining the start location of the set of SBFD symbols in the time domain based on the SLIV and the range in the time domain available for the SBFD operation.

In some example embodiments, the first apparatus may further comprise, in accordance with a determination that the length of the set of SBFD symbols exceeds the threshold length, obtaining, from the message, additional information indicating a number of additional symbols of the uplink transmission exceeding the threshold length; and means for determining the start location of the set of SBFD symbols based on the SLIV, the additional information and the range in the time domain available for the SBFD operation.

In some example embodiments, the start location of the set of SBFD symbols in the time domain is determined based on a start symbol index indicated by the SLIV and the range in the time domain available for the SBFD operation.

In some example embodiments, the first apparatus may further comprise means for, in accordance with a determination that a start location of the set of SBFD symbols corresponding to a start symbol index indicated by the SLIV is out of a boundary of the first SBFD slot in the at least two consecutive slots, determining a new start symbol index based on the start symbol index indicated by the SLIV, the total number of SBFD symbols in the first SBFD slot and a location of the first SBFD symbol in the first SBFD slot; and means for determining the start location of the set of SBFD symbols in the time domain based on the new start symbol index and the range in the time domain available for the SBFD operation.

In some example embodiments, the first apparatus may further comprise means for obtaining, from the message, additional information indicating whether a length of the set of SBFD symbols spans across more than two consecutive slots.

In some example embodiments, an apparatus capable of performing the method 700 (for example, implemented at the second apparatus 120) may include means for performing the respective steps of the method 700. The means may be implemented in any suitable form. For example, the means may be implemented in a circuitry or software module.

In some example embodiments, the second apparatus comprises means for determining, at a second apparatus, a message indicating time domain resource allocation for an uplink transmission that spans across at least two consecutive slots and that comprises a set of SBFD symbols; and means for transmitting the message to a first apparatus.

In some example embodiments, the second apparatus 120 may further comprise means for transmitting, to the first apparatus, information of a range in a time domain available for a SBFD operation.

In some example embodiments, the second apparatus 120 may further comprise means for transmitting, to the first apparatus, a SLIV in the message, wherein a start symbol index indicated by the SLIV is corresponding to a start location of the set of SBFD symbols in the time domain of the range available for the SBFD operation.

FIG. 8 is a simplified block diagram of a device 800 that is suitable for implementing example embodiments of the present disclosure. The device 800 may be provided to implement a communication device, for example, the first apparatus 110 or the second terminal device 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus at least to:
receive, from a second apparatus, a message indicating time domain resource allocation for an uplink transmission that spans across at least two consecutive slots and that comprises a set of subband full duplex, SBFD, symbols;
determine a start location of the set of SBFD symbols in a time domain at least based on the message; and
perform the uplink transmission to the second apparatus at least based on the start location of the set of SBFD symbols.

2. The first apparatus of claim 1, wherein the first apparatus is caused to:
determine a range in a time domain available for a SBFD operation;
obtain a start and length indicator value, SLIV, from the message; and
determine the location of the set of SBFD symbols in the time domain at least based on the range and the SLIV.

3. The first apparatus of claim 2, wherein the first apparatus is caused to:
in accordance with a determination that a length of the set of SBFD symbols does not exceed a threshold length and physical uplink shared channel, PUSCH, mapping Type A or PUSCH mapping Type B,
determine the start location of the set of SBFD symbols in the time domain based on the SLIV and the range in the time domain available for the SBFD operation.

4. The first apparatus of claim 3, wherein the first apparatus is caused to:
in accordance with a determination that the length of the set of SBFD symbols exceeds the threshold length, obtain, from the message, additional information indicating a number of additional symbols of the uplink transmission exceeding the threshold length; and
determine the start location of the set of SBFD symbols based on the SLIV, the additional information and the range in the time domain available for the SBFD operation.

5. The first apparatus of any of claims 2-4, wherein the start location of the set of SBFD symbols in the time domain is determined based on a start symbol index indicated by the SLIV and the range in the time domain available for the SBFD operation.

6. The first apparatus of claim 2, wherein the first apparatus is caused to:
in accordance with a determination that a start location of the set of SBFD symbols corresponding to a start symbol index indicated by the SLIV is out of a boundary of the first SBFD slot in the at least two consecutive slots, determine a new start symbol index based on the start symbol index indicated by the SLIV, the total number of SBFD symbols in the first SBFD slot and a location of the first SBFD symbol in the first SBFD slot; and
determine the start location of the set of SBFD symbols in the time domain based on the new start symbol index and the range in the time domain available for the SBFD operation.

7. The first apparatus of claim 6, wherein the first apparatus is caused to:
obtain, from the message, additional information indicating whether a length of the set of SBFD symbols spans across more than two consecutive slots.

8. A second apparatus comprising:
at least one processor; and
at least one memory storing instructions that, when executed by the at least one processor, cause the second apparatus at least to:
determine a message indicating time domain resource allocation for an uplink transmission that spans across at least two consecutive slots and that comprises a set of subband full duplex, SBFD, symbols; and
transmit the message to a first apparatus.

9. The second apparatus of claim 8, wherein the second apparatus is caused to:
transmit, to the first apparatus, information of a range in a time domain available for a SBFD operation.

10. The second apparatus of claim 8, wherein the second apparatus is caused to:
transmit, to the first apparatus, a start and length indicator value, SLIV, in the message, wherein a start symbol index indicated by the SLIV is corresponding to a start location of the set of SBFD symbols in the time domain of the range available for the SBFD operation.

11. A method comprising:
receiving, at a first apparatus and from a second apparatus, a message indicating time domain resource allocation for an uplink transmission that spans across at least two consecutive slots and that comprises a set of subband full duplex, SBFD, symbols;
determining a start location of the set of SBFD symbols in a time domain at least based on the message; and
performing the uplink transmission to the second apparatus at least based on the start location of the set of SBFD symbols.

12. The method of claim 11, further comprising:
determining a range in a time domain available for a SBFD operation;
obtaining a start and length indicator value, SLIV, from the message; and
determining the location of the set of SBFD symbols in the time domain at least based on the range and the SLIV.

13. The method of claim 12, further comprising:
in accordance with a determination that a length of the set of SBFD symbols does not exceed a threshold length and a physical uplink shared channel, PUSCH mapping type A or PUSCH mapping type B, determining the start location of the set of SBFD symbols in the time domain based on the SLIV and the range in the time domain available for the SBFD operation.

14. The method of claim 13, further comprising:
in accordance with a determination that the length of the set of SBFD symbols exceeds the threshold length, obtaining, from the message, additional information indicating a number of additional symbols of the uplink transmission exceeding the threshold length; and
determining the start location of the set of SBFD symbols based on the SLIV, the additional information and the range in the time domain available for the SBFD operation.

15. The method of any of claims 12-14, wherein the start location of the set of SBFD symbols in the time domain is determined based on a start symbol index indicated by the SLIV and the range in the time domain available for the SBFD operation.

16. The method of claim 12, further comprising:
in accordance with a determination that a start location of the set of SBFD symbols corresponding to a start symbol index indicated by the SLIV is out of a boundary of the first SBFD slot in the at least two consecutive slots, determining a new start symbol index based on the start symbol index indicated by the SLIV, the total number of SBFD symbols in the first SBFD slot and a location of the first SBFD symbol in the first SBFD slot; and
determining the start location of the set of SBFD symbols in the time domain based on the new start symbol index and the range in the time domain available for the SBFD operation.

17. The method of claim 16, further comprising:
obtaining, from the message, additional information indicating whether a length of the set of SBFD symbols spans across more than two consecutive slots.

18. A method comprising:
determining, at a second apparatus, a message indicating time domain resource allocation for an uplink transmission that spans across at least two consecutive slots and that comprises a set of subband full duplex, SBFD, symbols; and
transmitting the message to a first apparatus.

19. The method of claim 18, further comprising:
transmitting, to the first apparatus, information of a range in a time domain available for a SBFD operation.

20. The method of claim 18, further comprising:
transmitting, to the first apparatus, a start and length indicator value, SLIV, in the message, wherein a start symbol index indicated by the SLIV is corresponding to a start location of the set of SBFD symbols in the time domain of the range available for the SBFD operation.

21. A first apparatus comprising:
means for receiving, from a second apparatus, a message indicating time domain resource allocation for an uplink transmission that spans across at least two consecutive slots and that comprises a set of subband full duplex, SBFD, symbols;
means for determining a start location of the set of SBFD symbols in a time domain at least based on the message; and
means for performing the uplink transmission to the second apparatus at least based on the start location of the set of SBFD symbols.

22. A second apparatus comprising:
means for determining, at a second apparatus, a message indicating time domain resource allocation for an uplink transmission that spans across at least two consecutive slots and that comprises a set of subband full duplex, SBFD, symbols; and
means for transmitting the message to a first apparatus.

23. A computer readable medium comprising instructions which, when executed by an apparatus, cause the apparatus to perform at least the method of any of claims 11-17, or the method of any of claims 18-20.
